(19) United States
(12) Patent Application Publication
(10) Pub. No.: US 2011/0043968 A1
(43) Pub. Date: Feb. 24, 2011

(54) Hybrid super capacitor

(75) Inventors: Hak Kwan Kim, Hanam (KR); Hyun Chul Jung, Yongin (KR); Dong Hyeok Choi, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO MECHANICS CO., LTD., Suwon (KR)

(21) Appl. No.: 12/654,259

(22) Filed: Dec. 15, 2009

(30) Foreign Application Priority Data
Jul. 1, 2009 (KR) 10-2009-0059691

(51) Int. Cl. H01G 9/04

(52) U.S. Cl. 361/528

(57) ABSTRACT

There is provided a super capacitor employing a novel hybrid system. The super capacitor includes an anode comprising a transition metal oxide, a cathode comprising a carbide pre-doped with Li ions, a separator disposed between the anode and the cathode to separate the anode and the cathode from each other, and an electrolyte contacting the anode and the cathode.

### CROSS-REFERENCE TO RELATED APPLICATIONS

This application claims the priority of Korean Patent Application No. 10-2009-0059691 filed on Jul. 1, 2009 in the Korean Intellectual Property Office, the disclosure of which is incorporated herein by reference.

### BACKGROUND OF THE INVENTION

1. Field of the Invention

The present invention relates to a super capacitor, and more particularly, to a hybrid super capacitor having a high energy density.

2. Description of the Related Art

A stable energy supply has become more crucial in a variety of electronic products such as information communications devices. In general, this energy supply is performed by capacitors. Capacitors store and supply electricity in circuits for various electronic products, and stabilize the flow of electricity in the circuits. Typical capacitors have long useful lives, short charge and discharge periods and high output densities; however they have considerably low energy densities, which cause limitations in the use of these typical capacitors as storage devices.

Therefore, new types of capacitors are under development, such as super capacitors having superior output densities while having short charge and discharge periods. Such capacitors are drawing much attention for use as new generation energy storage devices, as well as with secondary batteries.

Super capacitors are classified into three types according to their electrode materials and mechanisms. That is, super capacitors may be classified into the following types: electric double layer capacitors (EDLCs) using activated carbon as their electrodes and adopting an electric-charge absorption mechanism in electrical double layers; metal oxide electrode pseudo-capacitors (also referred to as ‘redox capacitors’) using transition metal oxides and conducting polymers for electrodes and adopting a mechanism regarding pseudo-capacitance; and hybrid capacitors having intermediate characteristics between the EDLCs and electrolytic capacitors.

Among those capacitors, EDLCs among the above super capacitors, which utilize activated carbon materials, are currently the most widely used capacitors.

The basic structure of an EDLC includes an electrode having a relatively large surface area such as a porous electrode, an electrolyte, a current collector, and a separator. The EDLC operates on the basis of an electrochemical mechanism generated when ions in the electrolyte flow along an electric field due to a voltage being applied to both terminals of a unit cell electrode, and are absorbed onto an electrode surface.

In the EDLC, an activated carbon is used as an electrode material in general. Since a specific capacitance is proportional to a specific surface area, the activated carbon rendering an electrode porous increases the capacity of the electrode material and thus increases an energy density. The porous electrode material may be activated carbon, activated carbon fiber, amorphous carbon, a carbon aerogel, a carbon composite material, or carbon nanotubes.

However, despite the high specific surface area of the activated carbon, the activated carbon has the following limitations. The pores of the activated carbon are mostly fine pores having a diameter of about 20 nm or less, which do not contribute to the function of an electrode, and effective pores thereof are merely 20% of the totality of pores. Furthermore, an electrode, in actuality, is fabricated by mixing a binder, a conducting carbon agent, a solvent or the like in order to produce a slurry. This further reduces the actual effective contact area between an electrode and an electrolyte. In addition, the degree of contact resistance between an electrode and a current collector, and a capacitance range thereof vary according to fabrication methods.

As for a redox capacitor using a metal oxide as an electrode material, a transition metal oxide is advantageous in terms of capacitance and has lower resistance than activated carbon. For this reason, the metal oxide may contribute to fabricating a high-output super capacitor. Also, it has been known that using an amorphous hydrate as an electrode material increases the specific capacitance of an electrode significantly. Although having higher capacitance than an EDLC, the redox capacitor has the following limitations: manufacturing costs which are more than double those of the EDLC, a high degree of difficulty in the manufacturing process, and high parasitic serial resistance (ESR).

As for hybrid capacitors developed in an effort to incorporate the advantages of the above capacitors, studies are being actively conducted in order to increase operating voltages and enhance energy densities by using an asymmetric electrode structure. In detail, one electrode utilizes a material having the characteristic of an electrode double layer, that is, carbon, thereby maintaining an output characteristic, while the other electrode utilizes an electrode implementing a redox mechanism with a high-capacitance characteristic, thereby achieving enhanced overall cell energy.

Although capacitance and energy density can be enhanced in the above hybrid capacitors, properties regarding charge/discharge or the like have not been optimized yet, and the non-linearity of such hybrid capacitors hinders the generalization thereof.

### SUMMARY OF THE INVENTION

An aspect of the present invention provides a high-capacitance super capacitor adopting a novel system that combines the high operating voltage characteristics of a lithium ion hybrid capacitor with the high capacitance characteristics of a redox pseudo-capacitor.

According to an aspect of the present invention, there is provided a super capacitor including: an anode including a transition metal oxide; a cathode including a carbide pre-doped with Li ions; a separator disposed between the anode and the cathode to separate the anode and the cathode from each other; and an electrolyte contacting the anode and the cathode.

The transition metal oxide may be expressed as MOₓ where M is at least one selected from the group consisting of Sc, Ti, V, Cr, Mn, Fe, Co, Ni, Cu, Zn and Ru.

For example, the transition metal oxide for the anode may be at least one selected from the group consisting of MnOₓ, NiOₓ, RuOₓ, CoOₓ and ZnO. The anode may be a mixture of the transition metal oxide and another active material, which may utilize a carbon, a conducting polymer or a mixture thereof.

The cathode may be a graphite electrode pre-doped with the Li ions.

The electrolyte may be an aqueous electrolyte, a non-aqueous electrolyte or an ionic liquid.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a side cross-sectional view illustrating a super capacitor according to an exemplary embodiment of the present invention;

FIG. 2 illustrates one example of charge-discharge curves of an anode and a cathode of a super capacitor according to an exemplary embodiment of the present invention.

FIG. 3 illustrates charge-discharge curves of a Li ion hybrid capacitor providing a cathode applicable to a super capacitor according to the present invention;

FIG. 4 illustrates charge-discharge curves of a redox pseudo-capacitor providing an anode applicable to a super capacitor according to the present invention; and

FIG. 5 is a graph for comparison in energy density between a comparative example and a hybrid super capacitor according to this embodiment of the present invention.

### DETAILED DESCRIPTION OF THE PREFERRED EMBODIMENT

Exemplary embodiments of the present invention will now be described in detail with reference to the accompanying drawings.

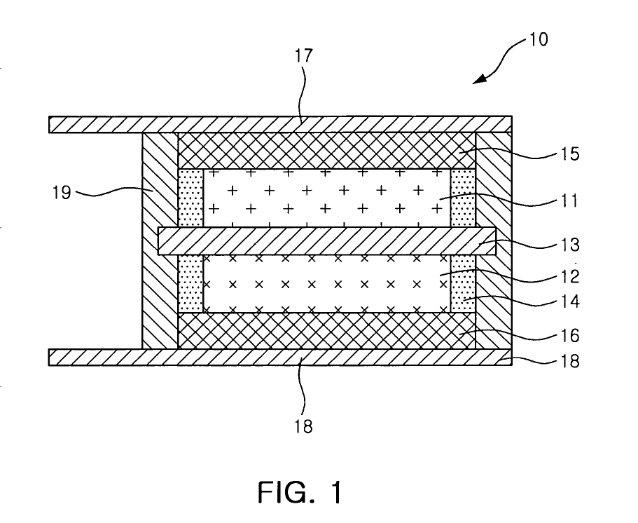

FIG. 1 is a side cross-sectional view illustrating a super capacitor according to an exemplary embodiment of the present invention.

According to this embodiment, the basic cell structure of a super capacitor 10 includes an anode 11, a cathode 12, a separator 13 separating the anode 11 and the cathode 12 from each other, and an electrolyte 14 contacting the anode 11 and the cathode 12.

According to this embodiment, the anode 11 contains a transition metal oxide, and the cathode 12 contains a carbide pre-doped with lithium (Li) ions. The anode 11 employed in this embodiment contains a similar electrode material to that of the anode of a redox pseudo-capacitor, while the cathode 12 employed in this embodiment contains a similar electrode material to that of the cathode of a lithium ion hybrid capacitor.

The transition metal oxide used for the anode 11 may be expressed as MOₓ where M is at least one kind of transition metal and may be at least one selected from the group consisting of Sc, Ti, V, Cr, Mn, Fe, Co, Ni, Cu, Zn and Ru.

For example, the transition metal oxide for the anode 11 may be MnOₓ, NiOₓ, RuOₓ, CoOₓ or ZnO. The anode 11 may be formed solely of the transition metal oxide. Alternatively, the anode 11 may be formed of a mixture of the transition metal oxide and another active material, which may be one of carbon, a conducting polymer or a mixture thereof.

The cathode 12 may be a graphite pre-doped with lithium.

As for the electrolyte 14 according to this embodiment, a known electrolyte that can apply current between the anode 11 and the cathode 12 may be used. Examples of the electrolyte 14 may include an aqueous electrolyte, a non-aqueous electrolyte or an ionic liquid.

The hybrid super capacitor 10, depicted in FIG. 1, may include a housing 19 accommodating the anode 11, the cathode 12, the separator 13 and the electrolyte 14, current collectors 15 and 16 respectively connected to the anode 11 and the cathode 12, and terminals 17 and 18 respectively connected the current collectors 15 and 16, respectively.

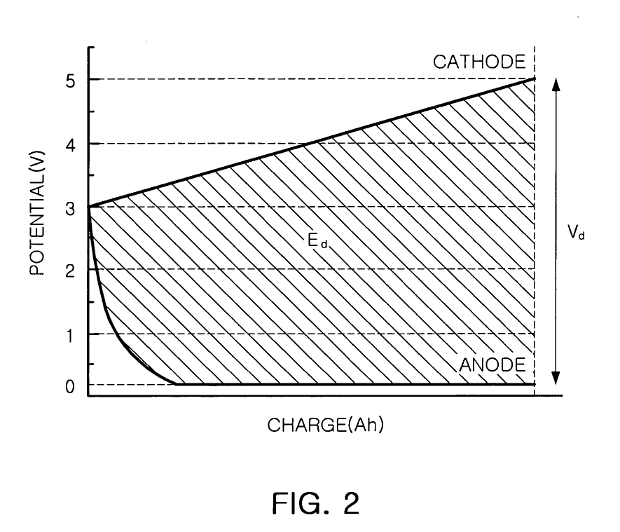

FIG. 2 illustrates one example of charge-discharge curves of an anode and a cathode in a super capacitor according to an exemplary embodiment of the present invention.

Referring to FIG. 2, the charge-discharge curve is associated with a super capacitor including the anode 11 containing a transition metal oxide and the cathode 12 containing a carbide pre-doped with Li ions.

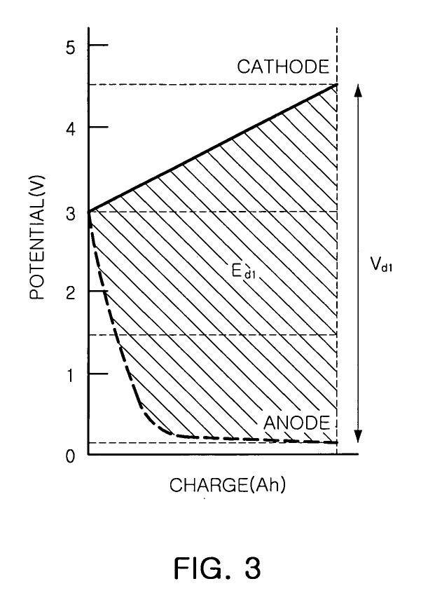

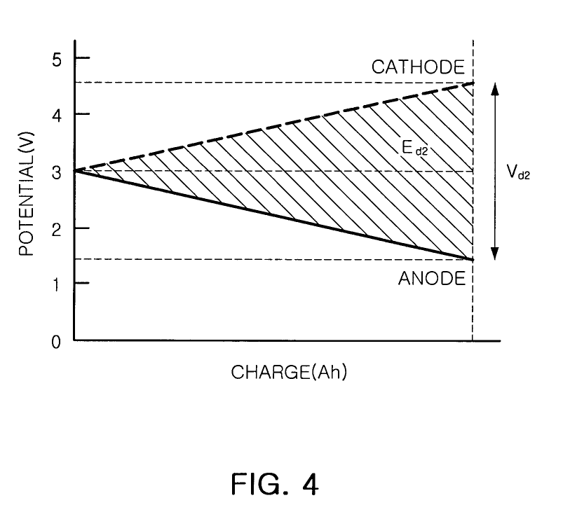

The super capacitor according to this embodiment can have a high operating voltage of about 4V, which is similar to that of an existing Li-ion hybrid capacitor (see FIG. 3), while ensuring high capacitance by employing a transition metal oxide as an anode as in the anode of an existing redox pseudo-capacitor (see FIG. 4).

That is, according to this embodiment, a new hybrid super capacitor having high capacitance without voltage loss is provided by combining the characteristic of high operating voltage in the existing Li-ion hybrid capacitor with the characteristic of high capacitance in the existing redox pseudo-capacitor.

In general, two methods are widely used in order to increase the energy density of a super capacitor. One is to increase the capacitance of an electrode material, and the other is to increase operating voltage.

To increase the capacitance of an electrode material, a contact area with an electrolyte may be increased or a redox reaction on the surface of an electrode may be generated. This may achieve more than a ten-fold increase in capacitance as compared to an EDLC.

Accordingly, as shown in FIG. 4, a redox pseudo-capacitor using a redox reaction may provide high capacitance. However, it is difficult for a general electrolyte to increase an operating voltage V_{d1} to 3 V or higher. Such low operating voltage causes limitations in increasing energy density E_{d1} despite high capacitance.

The energy density of a capacitor is proportional to the square of operating voltage. Thus, raising operating voltage may work more effectively in increasing energy density. An example of this type of capacitor is a Li ion hybrid capacitor. FIG. 3 illustrates charge-discharge curves of a Li ion hybrid capacitor. The Li ion hybrid capacitor may have high operating voltage (e.g., 4.2 V) by using a carbide electrode pre-doped with Li ions. However, this Li ion hybrid capacitor has a structure based on an EDLC, and thus has relatively low capacitance.

According to the present invention, to incorporate the advantages of these two capacitor structures, a transition metal oxide used for the anode of the capacitor having the charge-discharge curve of FIG. 4 is utilized for an anode, and a carbide pre-doped with lithium ions used for the cathode of the capacitor having the charge-discharge curve of FIG. 3 is utilized for a cathode. In this way, a bew hybrid super capacitor is provided, which can increase capacitance by more than ten times without dropping operating voltage.

Using this hybrid structure may realize a super capacitor having an energy density of about 150 wh/kg to 200 wh/kg, which is about ten times greater the average energy density of 15 wh/kg to 20 wh/kg of an existing Li ion hybrid capacitor. This super capacitor may be expected to substitute for an existing secondary battery.

Hereinafter, the operation and effect of the present invention will be described in more detail on the basis of the concrete inventive example of the present invention.

### Inventive Example

In this inventive example, an anode containing a transition metal oxide was produced. MnSO₄ was put into 500 ml of DI water and stirred to form a mixture thereof. Additionally, NiCl and CoCl₂ were added to the mixture to induce the precipitation of MnO₄. A resultant mixture solution was stirred for about 4 hours to 15 hours and was then dried at a temperature of about 120° C. for about 12 hours. Thereafter, a centrifugation process was performed so as to remove undesired K and Cl elements from the dried resultant material, thereby finally obtaining desired fine MnO₂ powder.

This fine MnO₂ powder acting as an active material, acetylene black serving as a conducting material, polyvinylidene fluoride (PVDF), styrene butadiene rubber (SBR) or carboxymethylcellulose (CMC) serving as a binder, and N-Methyl-2-Pyrrolidone (NMP) serving as a solvent were mixed together at the proper ratio of 8:1:1:15, thereby producing a slurry. This slurry was applied to an Al current conductor and dried, thereby producing an electrode.

Thereafter, a carbon cathode doped with Li ions was produced. In detail, Li metal foil was adhered to a carbon-based graphite or an activated carbon, and was deposited in an electrolyte, thereby performing the pre-doping of Li+ions.

Thereafter, a hybrid super capacitor of this inventive example was fabricated using the Li-doped carbon electrode as its cathode, and using the transition metal oxide electrode as its anode by the use of the binder and the Al foil current collector. A non-aqueous solution of 0.5M LiBF4+0.5M Et4NBF4/PC was used as an electrolyte.

### Comparative Example

A typical EDLC super capacitor, using activated carbon electrodes as a cathode and an anode, was fabricated. In detail, two activated carbon-based anode and cathode were produced by using a mixture binder such as polytetrafluoroethylene (PTFE), styrene butadiene rubber (SER) or carboxymethylcellulose (CMC) and distilled water, and an electrolyte of 1M Et4NBF4/PC was used, thereby fabricating the typical EDLC super capacitor.

The hybrid super capacitor fabricated according to this inventive example (carbon cathode pre-doped with Li ions/transition metal oxide anode), and the super capacitor fabricated according to the comparative example (activated carbon cathode/activated carbon anode) were evaluated in terms of electro-chemical characteristics.

As for a counter electrode and a reference electrode, a platinum (Pt) electrode and a saturated calomel electrode (SCE) were used, respectively. An electrolyte utilized a non-aqueous solution of 0.5M LiBF4+0.5M Et4NBF4/PC.

For a characteristic estimation similar to the actual case of product fabrication, cyclic voltammetry (CV) and a voltage-time (V-t) curve were measured by testing two electrode cells, thereby estimating capacitance.

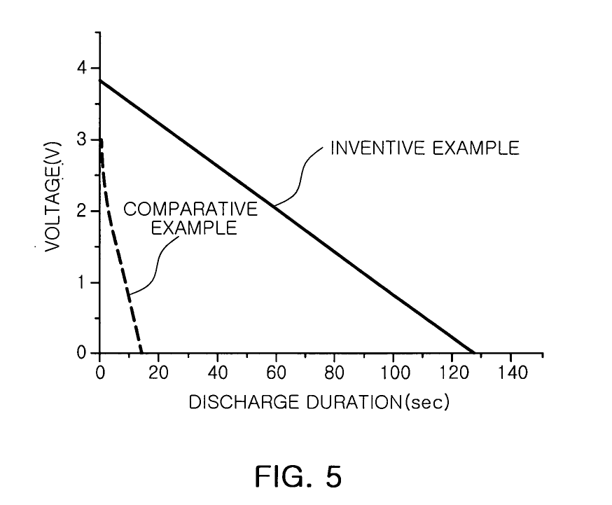

As a result, as shown in FIG. 5, it can be clearly seen that a hybrid capacitor fabricated according to this inventive example achieves a significant improvement in energy density by having a higher voltage and higher capacitance than an existing EDLC using an activated carbon, due to its wider voltage range and greater capacitance.

As set forth above, according to exemplary embodiments of the present invention, the high capacitance of the redox pseudo-capacitor and the high operating voltage of the Li ion hybrid capacitor are combined, thereby ensuring high operating voltage as well as capacitance as high as that of a related art secondary battery. Also, energy density can be enhanced by controlling the resistance of a cathode material.

While the present invention has been shown and described in connection with the exemplary embodiments, it will be apparent to those skilled in the art that modifications and variations can be made without departing from the spirit and scope of the invention as defined by the appended claims.

What is claimed is:

1. A super capacitor comprising:
an anode comprising a transition metal oxide;
a cathode comprising a carbide pre-doped with lithium (Li) ions;
a separator disposed between the anode and the cathode to separate the anode and the cathode from each other; and
an electrolyte contacting the anode and the cathode.

2. The super capacitor of claim 1, wherein the transition metal oxide is expressed as MOₓ where M is at least one selected from the group consisting of Sc, Ti, V, Cr, Mn, Fe, Co, Ni, Cu, Zn and Ru.

3. The super capacitor of claim 2, wherein the transition metal oxide is at least one selected from the group consisting of MnOₓ, NiOₓ, RuOₓ, CoOₓ, and ZnO.

4. The super capacitor of claim 1, wherein the anode is a mixture of the transition metal oxide and another active material.

5. The super capacitor of claim 4, wherein the another active material is a carbon, a conducting polymer or a mixture thereof.

6. The super capacitor of claim 1, wherein the cathode is a graphite electrode pre-doped with the Li ions.

7. The super capacitor of claim 1, wherein the electrolyte is an aqueous electrolyte, a non-aqueous electrolyte or an ionic liquid.
